(19) United States
(12) Patent Application Publication
(10) Pub. No.: US 2022/0347813 A1
(43) Pub. Date: Nov. 3, 2022

(54) MONITOR CHEMICAL MECHANICAL POLISHING PROCESS USING MACHINE LEARNING BASED PROCESSING OF HEAT IMAGES

(71) Applicant: Applied Materials, Inc., Santa Clara, CA (US)

(72) Inventors: Thomas H. Osterheld, Mountain View, CA (US); Benjamin Cherian, San Jose, CA (US)

(21) Appl. No.: 17/730,811

(22) Filed: Apr. 27, 2022

Related U.S. Application Data
(60) Provisional application No. 63/182,613, filed on Apr. 30, 2021.

(51) Int. Cl. B24B 37/005

(52) U.S. Cl. CPC B24B 37/005

(57) ABSTRACT

A chemical mechanical polishing apparatus includes a platen having a top surface to hold a polishing pad, a carrier head to hold a substrate against a polishing surface of the polishing pad during a polishing process, a temperature monitoring system including a non-contact thermal imaging camera positioned above the platen to have a field of view of a portion of the polishing pad on the platen, and a controller. The controller is configured to receive the thermal image from the temperature monitoring system, input the thermal image into a machine learning model trained by training examples to determine an indication for one or more of 1) a presence of a process excursion, 2) a substrate state, or 3) a diagnosis for the process excursion, and receive from the machine learning model the indication.

### CROSS-REFERENCE TO RELATED APPLICATIONS

This claims the benefit of priority to U.S. Application No. 63/182,613, filed on Apr. 30, 2021, the contents of which are hereby incorporated by reference.

### TECHNICAL FIELD

The present disclosure relates to chemical mechanical polishing (CMP), and more specifically to monitoring to detect process drift or process abnormalities.

### BACKGROUND

An integrated circuit is typically formed on a substrate by the sequential deposition of conductive, semiconductive, or insulative layers on a silicon wafer. Planarization of a substrate surface may be required for the removal of a filler layer or to improve planarity for photolithography during fabrication of the integrated circuit.

Chemical mechanical polishing (CMP) is one accepted method of planarization. This planarization method typically requires that the substrate be mounted on a carrier or polishing head. The exposed surface of the substrate is typically placed against a rotating polishing pad. The carrier head provides a controllable load on the substrate to push it against the polishing pad. An abrasive polishing slurry is typically supplied to the surface of the polishing pad.

Various in-situ monitoring systems, e.g., optical or eddy current monitoring systems, can be used to measure the thickness of the substrate layer during polishing. Thermal imaging of the substrate using infrared camera has also been proposed.

As a parallel issue, advancements in hardware resources such as Graphical Processing Units (GPU) and Tensor Processing Units (TPU) have resulted in a vast improvement in the deep learning algorithms and their applications. One of the evolving fields of deep learning is computer vision and image recognition. Such computer vision algorithms are mostly designed for image classification or segmentation.

### SUMMARY

In one aspect, a chemical mechanical polishing apparatus includes a platen having a top surface to hold a polishing pad, a carrier head to hold a substrate against a polishing surface of the polishing pad during a polishing process, a temperature monitoring system including a non-contact thermal imaging camera positioned above the platen to have a field of view of a portion of the polishing pad on the platen, and a controller. The controller is configured to receive the thermal image from the temperature monitoring system, input the thermal image into a machine learning model trained by training examples to determine an indication for one or more of 1) a presence of a process excursion, 2) a substrate state, or 3) a diagnosis for the process excursion, and receive from the machine learning model the indication.

Implementations can include, but are not limited to, one or more of the following potential advantages. Process variations across the polishing pad can be monitored at a low cost. Process variations may be detected in a more direct approach than in-situ substrate monitoring systems, and thus detection of process variations can be more reliable. This can improve predictability of the polishing process and improve within-wafer uniformity.

A low cost infrared (IR) camera can be mounted above the pad about an axis parallel to the polishing surface to take thermal images of the pad at specified time intervals during the process. This can permit collecting a large number, e.g., hundreds, of thermal images of the polishing. By using the thermal images as input to a machine learning process, the process anomalies can be better understood.

The described approach can be used to reconstruct the collected images and to train a model to output a state of a wafer based on an input image. This can facilitate the training of a more complicated model to understand physical anomalies causing deviations in the polishing process. For example, by using the collected images as input, the described approach can monitor wafer uniformity drifts, possible issues with the platen hardware, pad conditioning, possible issues with the retaining ring, variation in head pressure, and other issues during processing.

The deep learning in the metrology system can have high inference speed and still be able to achieve a high-resolution monitoring of process issues and drift. It enables the metrology system to be a fast and low-cost pre- and post-metrology measurement tool for memory applications with reduced issues of the process hardware performance.

The details of one or more embodiments set forth in the accompanying drawings and the description below. Other features, objects, and advantages will be apparent from the description and drawings, and from the claims.

### BRIEF DESCRIPTION OF THE DRAWINGS

FIG. 1A is a schematic cross-sectional view of an example polishing apparatus.

FIG. 1B is a schematic top view of the example polishing apparatus of FIG. 1A.

FIG. 2 illustrates a flow chart for a method of detecting a process drift using a deep learning approach.

FIG. 3 illustrates a neural network used as a part of the controller for the polishing apparatus.

Like reference symbols in the various drawings indicate like elements.

### DETAILED DESCRIPTION

During chemical mechanical polishing, a variety of issues can cause departure from the expected process (an “excursion”). For example, polishing rates may depart from the expected rates or non-uniform polishing rates can occur. Although variations in the polishing rate can be detected using in-situ substrate monitoring systems, e.g., optical or eddy current monitoring systems, such systems may not provide forewarning of a process excursion or provide sufficient information to identify a root cause of the excursion.

However, thermal imaging of the polishing pad can be used to detect and potentially identify process excursions. During the polishing process, a significant amount of heat is generated due to friction between the surface of the substrate and the polishing pad. If the pad temperature does not behave as expected, this can indicate a process excursion and an underlying problem. An infrared camera can be positioned above the polishing pad, e.g., immediately “downstream” of the carrier head, to collect thermal images of the polishing pad. By using the collected thermal images of the polishing pad as input to a machine learning system, process excursions can be detected. In addition, the thermal images can be used to identify or monitor drifting in the polishing rate across the substrate, and/or possible issues with the platen hardware, pad conditioning, retaining ring, or carrier head pressure.

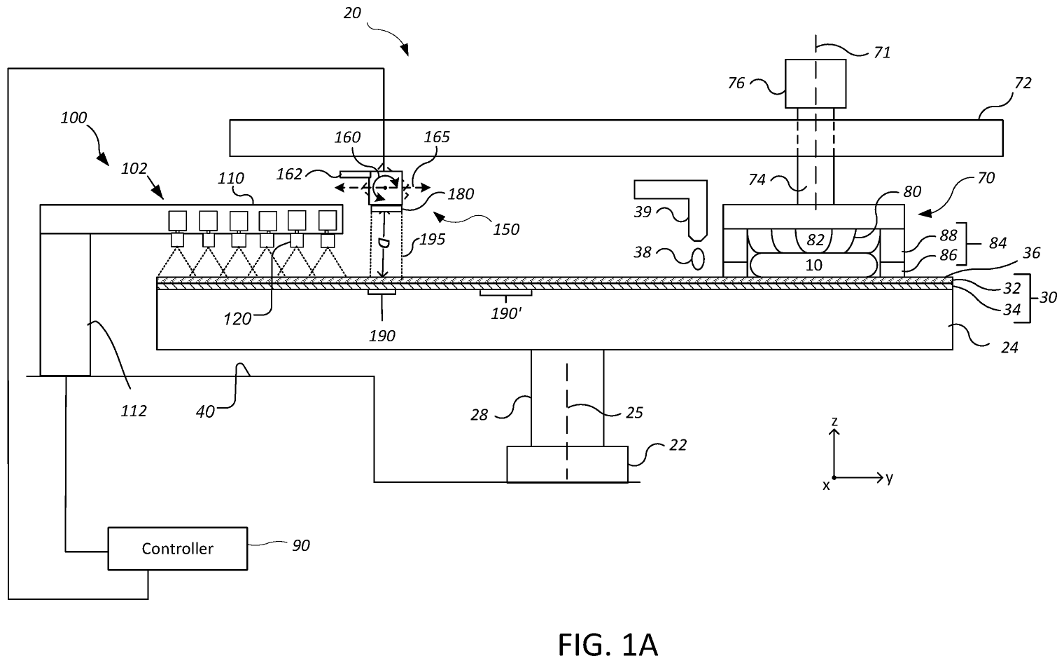

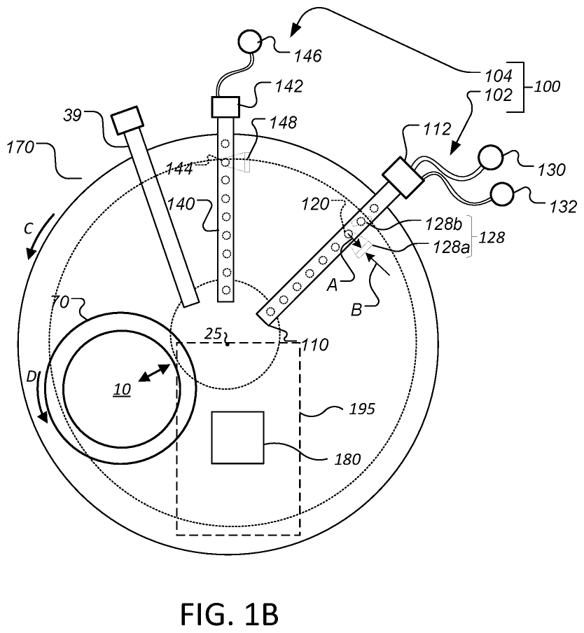

FIGS. 1A and 1B illustrate an example of a polishing station 20 of a chemical mechanical polishing system. The polishing station 20 includes a rotatable disk-shaped platen 24 on which a polishing pad 30 is situated. The platen 24 is operable to rotate about an axis 25. For example, a motor 22 can turn a drive shaft 28 to rotate the platen 24 (arrow C). The polishing pad 30 can be a two-layer polishing pad with an outer polishing layer 34 and a softer backing layer 32.

The polishing station 20 can include a supply port, e.g., at the end of a slurry supply arm 39, to dispense a polishing liquid 38, such as an abrasive slurry, onto the polishing pad 30. A carrier head 70 is operable to hold a substrate 10 against the polishing pad 30. The carrier head 70 is suspended from a support structure 72, e.g., a carousel or a track, and is connected by a drive shaft 74 to a carrier head rotation motor 76 so that the carrier head can rotate about an axis 71 (arrow D). Optionally, the carrier head 70 can oscillate laterally, e.g., on sliders on the carousel, by movement along the track, or by rotational oscillation of the carousel itself.

The carrier head 70 can include a retaining ring 84 to hold the substrate. In some implementations, the retaining ring 84 may include a lower plastic portion 86 that contacts the polishing pad, and an upper portion 88 of a harder material.

In operation, the platen is rotated about its central axis 25, and the carrier head is rotated about its central axis 71 and translated laterally across the top surface of the polishing pad 30.

The carrier head 70 can include a flexible membrane 80 having a substrate mounting surface to contact the back side of the substrate 10, and a plurality of pressurizable chambers 82 to apply different pressures to different zones, e.g., different radial zones, on the substrate 10. The carrier head can also include a retaining ring 84 to hold the substrate.

The polishing system 20 also includes a temperature control system 100 to control the temperature of the polishing pad 30 and/or slurry 38 on the polishing pad. The temperature control system 100 can include a cooling system 102 and/or a heating system 104. In some implementations one or both of the cooling system 102 and heating system 104 operate by delivering a temperature-control medium, e.g., a liquid, vapor or spray, onto the polishing surface 36 of the polishing pad 30 (or onto a polishing liquid that is already present on the polishing pad). For example, multiple nozzles 120 can be suspended from an arm 110 to dispense, e.g., spray, the temperature-control medium. Alternatively, at least one, and in some implementations both, of the cooling system 102 and heating system 104 operate by using a temperature-controlled plate that contacts the polishing pad to modify the temperature of the polishing pad by conduction. For example, the heating system 104 can use a hot plate, e.g., a plate with resistance heating or a plate with channels that carry a heating liquid. For example, the cooling system 102 can use a cold plate, e.g., a thermoelectric plate or a plate with channels that carry coolant liquid. As yet another alternative, the temperature control system 100 can include a heater, e.g., a resistive heater, embedded in the platen 24, or a temperature control fluid can flow through conduits in the platen 24.

Although FIG. 1B illustrates separate arms for each subsystem, e.g., the heating system 102, cooling system 104, and rinse system, various subsystems can be included in a single assembly supported by a common arm. For example, an assembly can include a cooling module, a rinse module, a heating module, a slurry delivery module, and optionally a wiper module.

Referring to FIGS. 1A and 1B, the polishing station 20 has a temperature monitoring system 150. The temperature monitoring system 100 includes a IR camera 180 positioned above the polishing pad 30. The IR camera 180 has a field of view 195 of a portion 190 of the polishing pad 30. In some implementations, e.g., as shown in FIG. 1A, the IR camera 180 is movable to change the portion of the pad being monitored. For example, the IR camera 180 can be rotatable (shown by arrow 160) or laterally movable (shown by arrow 165) by an actuator 162 so as to sweep the field of view 195 across different portions of the polishing pad 30. Alternatively, the IR camera 180 can be fixed in position, but have a sufficiently wide field of view 195 (e.g., as shown in FIG. 1B) as to cover the area of interest, e.g., a zone extending radially from the axis of rotation of the polishing pad to the pad edge. The IR camera 180 and its field of view 195 can be immediately “downstream” of the carrier head 70, i.e., further along the direction of rotation (arrow C) of the platen 24 and polishing pad 30. In particular, the field of view 195 is between the carrier head 70 and the arm(s) of the temperature control system 100.

A controller 90 can be configured to receive the images from the camera 180 and to operate the actuator(s) to control the position of the portion 190 being monitored.

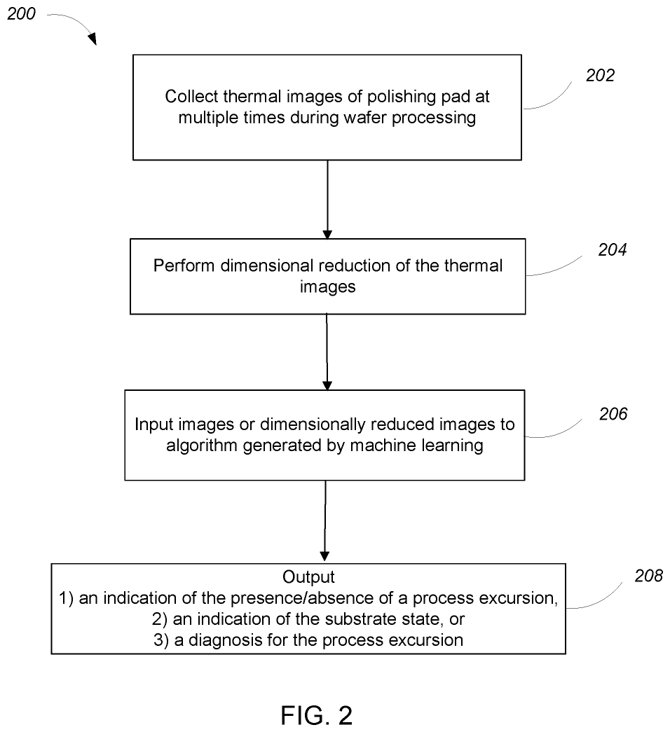

FIG. 2 illustrates a method 200 of image processing using an algorithm generated by machine learning techniques for use in a detecting process excursions.

Thermal images of the region of the polishing pad are collected from IR camera at multiple times during substrate processing (step 202). If the IR camera moves across the polishing pad, then optionally the controller can stitch multiple individual images into a single two-dimensional thermal image, although this may not be needed if the IR camera has a sufficiently wide field of view to cover the area of interest.

Optionally, the controller can apply dimensional reduction to the collected image (step 204). The image or the dimensionally reduced image is input to an algorithm, e.g., a neural network, generated by machine learning techniques (step 206). Depending on how the algorithm is trained, it can output one or more of 1) an indication of the presence/absence of a process excursion, 2) an indication of the substrate state, or 3) a diagnosis for the process excursion.

The algorithm, e.g., the neural network, can be trained to output an indication or diagnosis based on an input of a thermal image. The algorithm can be trained, e.g., in a training mode using backpropagation with a training data set. The training data set includes training thermal images and training values, with each training thermal image having an associated training value. In some implementations, the algorithm uses training data set that has thermal images of the polishing pad from multiple different times during polishing of a test substrate. In some implementations, the training values are one of only two states, e.g., “normal” or “abnormal.” In some implementations, the training values are one of only three states.

In some implementations, the training values indicate the presence or absence of a process excursion, e.g., “abnormal” or “normal.” The algorithm can thus be trained to output a “normal” or “not normal/abnormal” indication based on an input thermal image. This would permit the algorithm to output presence or absence of a process excursion.

In some implementations, the training values indicate a wafer state, e.g., “uniform”, “overpolished,” or “underpolished.” The algorithm can thus be trained to output a “uniform”, “overpolished,” or “underpolished” indication based on an input thermal image. This would permit the algorithm to output the expected wafer state.

In some implementations, the training values indicate a cause of an excursion, e.g., “normal,” “retaining ring worn”, “platen rotating too slow,” “carrier head chamber at wrong pressure,” etc. The algorithm can thus be trained to output a “normal,” “retaining ring worn”, “platen rotating too slow,” “carrier head chamber at wrong pressure,” etc., indication based on an input thermal image. This would permit the algorithm to generate an output indicative of the cause of an excursion.

In some implementations, the measured images are grouped in clusters. The reduced images or the clusters are analyzed by the algorithm and associated with a process excursion, the cause of the process excursion, or the state of the substrate. The deep learning-based algorithm, e.g., the neural network, is trained using the training data set. The training data set includes images with thermal measurements corresponding to the center of the polishing pad from the dry metrology tool labeled with various time stamps while training the model. For example, the model may be trained on about 50,000 images collected that have a wide range of states or anomalies.

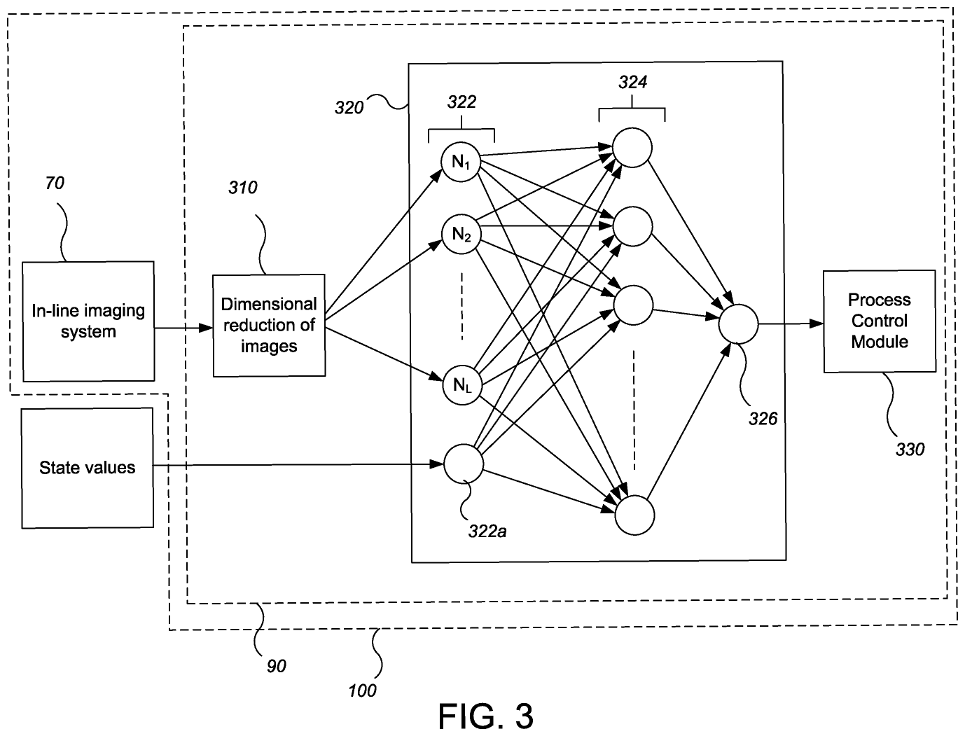

FIG. 3 illustrates a neural network 320 used as a part of the controller 190 for the polishing apparatus 100. The neural network 320 can be a deep neural network developed for regression analysis of the input thermal images from the polishing pad to generate a model to predict the process drift.

The neutral network 320 includes a plurality of input nodes 322. The neural network 320 can include an input node for each color channel associated with each pixel of the input color image, a plurality of hidden nodes 324 (also called “intermediate nodes” below), and an output node 326 that will generate the process measurement value. In a neural network having a single layer of hidden nodes, each hidden node 324 can be coupled to each input node 322, and the output node 326 can be coupled to each hidden node 320. However, as a practical matter, the neural network for image processing is likely to have many layers of hidden nodes 324.

In general, a hidden node 324 outputs a value that a non-linear function of a weighted sum of the values from the input nodes 322 or prior layers of hidden nodes to which the hidden node 324 is connected.

For example, the output of a hidden node 324 in the first layer, designated node k, can be expressed as:

tan h(0.5*ak1(I1)+ak2(I2)+ . . . +akM(IM)+bk) Equation 1

where tan h is the hyperbolic tangent, akx is a weight for the connection between the kth intermediate node and the xth input node (out of M input nodes), and IM is the value at the Mth input node. However, other non-linear functions can be used instead of tan h, such as a rectified linear unit (ReLU) function and its variants.

The neural network 320 thus includes an input node 322 for each color channel associated with each pixel of the input thermal image, e.g., where there are J pixels and K color channels, then L=J*K is number of intensity values in an input color image, and the neural network 320 will include at least input nodes N1, N2 . . . NL.

Thus, where the number of input nodes corresponds to the number of intensity values in the color image, the output Hk of a hidden node 324, designated node k, can be expressed as:

Hk=tan h(0.5*ak1(I1)+ak2(I2)+ . . . +akL(IL)+bk)

Assuming that the measured thermal image S is represented by a column matrix (i1, i2, . . . , iL), the output of an intermediate node 324, designated node k, can be expressed as:

Hk=tan h(0.5*ak1(V1·S)+ak2(V2·S)+ . . . +akL(VL·S)+bk) Equation 2

where V is a value (v1, v2, . . . , vL) of weights, with Vx being the weight for the xth intensity value out of L intensity values from the color image).

The output node 326 can generate a indicating value CV that is a weighted sum of the outputs of the hidden nodes. For example, this can be expressed as

CV=C1*H1+C2*H2+ . . . +CL*HL

where Ck is the weight for the output of the kth hidden node.

A correspondence between indicating values and textual descriptions for the indicating values can be stored in a look-up table.

However, the neural network 320 may optionally include one or more other input nodes (e.g., node 322a) to receive other data. This other data could be from a prior measurement of the polishing pad by the in-situ monitoring system, e.g., pixel intensity values collected from earlier in the process, e.g., pixel intensity values collected during processing of another substrate, from another sensor in the polishing system, e.g., a measurement of a temperature of the pad or substrate by a temperature sensor, from a polishing recipe stored by the controller that is used to control the polishing system, e.g., a polishing parameter such as carrier head pressure or platen rotation rate use for polishing the substrate, from a variable tracked by the controller, e.g., a number of substrates since the pad was changed, or from a sensor that is not part of the polishing system, e.g., a measurement of a thickness of underlying films by a metrology station. This permits the neural network 320 to take into account other processing or environmental variables in determination of the indication, e.g., the cause of an excursion.

The process anomaly indication generated at the output node 326 can be fed to a process control module 330. The process control module can adjust, based on the anomaly indication, the process parameters, e.g., carrier head pressure, platen rotation rate, etc. The adjustment can be performed for a polishing process to be performed on the substrate or a subsequent substrate.

For training, while the neural network 320 is operating in a training mode, such as a backpropagation mode, the values (v1, v2, . . . , vL) from the thermal image are fed to the respective input nodes N1, N2 . . . NL while a characteristic value CV representative of the indication is fed to the output node 326. This can be repeated for each row. This process sets the values for ak1, etc., in Equations 1 or 2 above.

The system is now ready for operation. A thermal image measured from the polishing pad using the in-line monitoring system 160 or the IR camera. The measured thermal image can be represented by a column matrix S=(i1, i2, . . . , iL), where ij represents the intensity value at the jth intensity value out of L intensity values, with L=3n when the image includes a total of n pixels and each pixel includes three color channels.

While the neural network 320 is used in an inference mode, these values (S1, S2, . . . , SL) are fed as inputs to the respective input nodes N1, N2, . . . NL. As a result, the neural network 320 generates a characteristic value, e.g., indicative of the presence or absence of a process anomaly, at the output node 326.

The architecture of the neural network 320 can vary in depth and width. For example, although the neural network 320 is shown with a single column of intermediate nodes 324, it could include multiple columns. The number of intermediate nodes 324 can be equal to or greater than the number of input nodes 322.

The above described polishing apparatus and methods can be applied in a variety of polishing systems. Either the polishing pad, or the carrier heads, or both can move to provide relative motion between the polishing surface and the substrate. For example, the platen may orbit rather than rotate. The polishing pad can be a circular (or some other shape) pad secured to the platen. The polishing layer can be a standard (for example, polyurethane with or without fillers) polishing material, a soft material, or a fixed-abrasive material.

Terms of relative positioning are used to refer to relative positioning within the system or substrate; it should be understood that the polishing surface and substrate can be held in a vertical orientation or some other orientation during the polishing operation.

Functional operations of the controller 90 can be implemented using one or more computer program products, i.e., one or more computer programs tangibly embodied in a non-transitory computer readable storage media, for execution by, or to control the operation of, data processing apparatus, e.g., a programmable processor, a computer, or multiple processors or computers.

A number of embodiments of the invention have been described. Nevertheless, it will be understood that various modifications may be made without departing from the spirit and scope of the invention. Accordingly, other embodiments are within the scope of the following claims.

Various deep model architectures were trained and validated on small die ILD0 test patterned substrates with a goal of reducing errors in the measurements. The model that took into consideration the characteristics of the underlying layer had a lower error. In addition, preliminary tool-to-tool matching validation was performed by training the model with data collected on one tool and using it for inferences on the data from other tools. Results were comparable to training and inferencing with data from the same tool.

In general, data can be used to control one or more operation parameters of the CMP apparatus. Operational parameters include, for example, platen rotational velocity, substrate rotational velocity, the polishing path of the substrate, the substrate speed across the plate, the pressure exerted on the substrate, slurry composition, slurry flow rate, and temperature at the substrate surface. Operational parameters can be controlled real-time and can be automatically adjusted without the need for further human intervention.

As used in the instant specification, the term substrate can include, for example, a product substrate (e.g., which includes multiple memory or processor dies), a test substrate, a bare substrate, and a gating substrate. The substrate can be at various stages of integrated circuit fabrication, e.g., the substrate can be a bare wafer, or it can include one or more deposited and/or patterned layers. The term substrate can include circular disks and rectangular sheets.

However, the color image processing technique described above can be particularly useful in the context of 3D vertical NAND (VNAND) flash memory. In particular, the layer stack used in fabrication of VNAND is so complicated that current metrology methods (e.g., Nova spectrum analysis) may be unable to perform with sufficient reliability in detecting regions of improper thickness. In contrast, the color image processing technique can have superior reliability in this application.

Embodiments of the invention and all of the functional operations described in this specification can be implemented in digital electronic circuitry, or in computer software, firmware, or hardware, including the structural means disclosed in this specification and structural equivalents thereof, or in combinations of them. Embodiments of the invention can be implemented as one or more computer program products, i.e., one or more computer programs tangibly embodied in a non-transitory machine readable storage media, for execution by, or to control the operation of, data processing apparatus, e.g., a programmable processor, a computer, or multiple processors or computers.

Terms of relative positioning are used to denote positioning of components of the system relative to each other, not necessarily with respect to gravity; it should be understood that the polishing surface and substrate can be held in a vertical orientation or some other orientations.

A number of implementations have been described. Nevertheless, it will be understood that various modifications may be made. Accordingly, other implementations are within the scope of the claims.

What is claimed is:

1. A chemical mechanical polishing apparatus comprising:
a platen having a top surface to hold a polishing pad;
a carrier head to hold a substrate against a polishing surface of the polishing pad during a polishing process;
a temperature monitoring system including a non-contact thermal imaging camera positioned above the platen to have a field of view of a portion of the polishing pad on the platen; and
a controller configured to receive the thermal image from the temperature monitoring system, input the thermal image into a machine learning model trained by training examples to determine an indication for one or more of 1) a presence of a process excursion, 2) a substrate state, or 3) a diagnosis for the process excursion, and receive from the machine learning model the indication.

2. The apparatus of claim 1, wherein the machine learning model is trained by the training examples to determine an indication for a presence of a process excursion.

3. The apparatus of claim 1, wherein the machine learning model is trained by the training examples to determine an indication for a substrate state.

4. The apparatus of claim 3, wherein the machine learning model is trained by the training examples to determine a state selected from a group including an underpolished state, an overpolished state, and a normal state.

5. The apparatus of claim 1, wherein the machine learning model is trained by training examples to determine an indication for a diagnosis for a process excursion.

6. The apparatus of claim 1, wherein the machine learning model comprises an artificial neural network.

7. The apparatus of claim 6, wherein the neural network comprises an input layer having a plurality of input nodes to receive intensity values from thermal image, an output layer having an output node to output a value indicative of indication, and one or more hidden layers between the input layer and the output layer.

8. The apparatus of claim 1, wherein the controller is configured to dimensionally reduce the thermal image and to input the dimensionally reduced thermal image to the machine learning model.

9. A computer program product, tangibly embodied in computer-readable media, comprising instructions to cause one or more computers to:
receive a thermal image from a temperature monitoring system;
input the thermal image into a machine learning model trained by training examples to determine an indication for one or more of 1) a presence of a process excursion, 2) a substrate state, or 3) a diagnosis for the process excursion; and
receive from the machine learning model the indication.

10. The computer program product of claim 9, wherein the machine learning model is trained by the training examples to determine an indication for a presence of a process excursion.

11. The computer program product of claim 9, wherein the machine learning model is trained by the training examples to determine an indication for a substrate state.

12. The computer program product of claim 11, wherein the machine learning model is trained by the training examples to determine a state selected from a group including an underpolished state, an overpolished state, and a normal state.

13. The computer program product of claim 9, wherein the machine learning model is trained by training examples to determine an indication for a diagnosis for a process excursion.

14. The computer program product of claim 9, wherein the machine learning model comprises an artificial neural network.

15. The computer program product of claim 6, wherein the artificial neural network comprises an input layer having a plurality of input nodes to receive intensity values from thermal image, an output layer having an output node to output a value indicative of indication, and one or more hidden layers between the input layer and the output layer.

16. The computer program product of claim 6, wherein the controller is configured to dimensionally reduce the thermal image and to input the dimensionally reduced thermal image to the machine learning model.

17. A method of operating a polishing apparatus, comprising:
polishing a substrate with a polishing pad;
obtaining a thermal image of a portion of the polishing pad during polishing;
inputting the thermal image into a machine learning model trained by training examples to determine an indication for one or more of 1) a presence of a process excursion, 2) a substrate state, or 3) a diagnosis for the process excursion; and
receiving from the machine learning model the indication.

18. The method of claim 16, wherein the machine learning model is trained by the training examples to determine an indication for a presence of a process excursion.

19. The method of claim 16, wherein the machine learning model is trained by the training examples to determine an indication for a substrate state.

20. The method of claim 16, wherein the machine learning model is trained by training examples to determine an indication for a diagnosis for a process excursion.

21. The method of claim 16, wherein the machine learning model comprises an artificial neural network.

22. The method of claim 21, wherein the artificial neural network comprises an input layer having a plurality of input nodes to receive intensity values from thermal image, an output layer having an output node to output a value indicative of indication, and one or more hidden layers between the input layer and the output layer.
